(19) United States
(12) Patent Application Publication
(10) Pub. No.: US 2005/0050243 A1
(43) Pub. Date: Mar. 3, 2005

(54) Modified core-edge topology for a fibre channel network

(76) Inventor: Stacey A. Clark, Wellington, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/651,875

(22) Filed: Aug. 29, 2003

(51) Int. Cl. G06F 13/00

(52) U.S. Cl. 710/33

(57) ABSTRACT

A modified core-edge topology for a Fibre Channel network includes a server, a first edge switch connected to the server, a first core switch connected to the first edge switch, a second edge switch connected to the server, a second core connected to the second edge switch and a storage subsystem connected to the first and second core switches. This topology creates a first, discrete fabric consisting of the server, the first edge and core switches in the storage subsystem, and a second, discrete fabric formed by the server, second edge and core switches and storage subsystem. The advantage of this topology is that it utilizes the server itself to switch between fabrics, thereby providing redundancy. The result is a robust system in which there is no single component that will cause failure of communication between the server and storage subsystem. Moreover, the topology saves one port per switch on the edge and core switches when compared to prior art core-edge topologies, thereby providing a cost savings.

### BACKGROUND

The present invention relates to storage area networks and, more particularly, to storage area networks employing a core-edge topology between a network server and a storage server.

In mainframe computing environments, the storage of data typically is centralized and is connected to the host computer. However, with the explosion of data brought about by e-business and the advent of client/server computing systems, data that was centralized on a mainframe is now spread across a network that interconnects discrete storage devices with client computers, such as desktop computers. Accordingly, the storage area network (“SAN”) was created to provide a high speed network that allows the establishment of direct connections between storage devices or storage subsystems and application servers. The application servers, in turn, are connected to networks that communicate data to and from the storage devices or storage subsystems and desktop or personal computers.

There is a need to build resiliency into the SAN, as well as to insure that data are accessible by the desktops at all times. Accordingly, a SAN should include built-in redundancies to protect against data interruption resulting from the failure of a particular component. In addition, with a SAN it is possible to achieve higher utilization of the storage devices connected to it since every server in the SAN can access all of the storage capacity in the SAN. This results in a cost savings because fewer storage devices are required to provide a desired volume of storage. The Storage Network Industry Association (SNIA) defines SAN as “a network whose primary purpose is the transfer of data between computer systems and storage elements.” A SAN consists of a communication infrastructure that provides physical connections and a management layer that organizes the connections, storage elements and computer systems to insure that data transfer is secure and robust. Currently, Fibre Channel is the architecture on which most SAN implementations are built. Fibre Channel is a technology standard that allows data to be transferred from one network node to another at very high speeds.

The logical layout of the components of a computer system or network and their interconnections is called a topology. In order to provide maximum connections between nodes, switches have been developed to interconnect storage subsystems with application servers. The benefit of interposing switches is that switches can route data (“frames”) between nodes and establish a desired connection between an application server and a storage server only when needed. One or more interconnected Fibre Channel switches is called a fabric.

There are many different topologies that can be constructed using storage, server and switch components in a Fibre Channel network. An example of a versatile and configurable Fibre Channel topology is shown in FIG. 1. In FIG. 1, a core-edge topology, generally designated 10, interconnects application servers 12, 14 with storage subsystems 16, 18, shown here as enterprise storage servers (ESS). Servers 12, 14 may be a Windows and/or UNIX servers and, in turn, be connected to a local area network (LAN) or a wide area network (WAN) serving desktop units or personal computers (not shown). The application servers 12, 14 are connected to edge switches 20, 22, 24, by Fibre Channel cables, typically fiber optic cables. Server 12 is connected by Fibre Channel cables 26, 28, 30 to edge switches 20, 22, 24, respectively, and server 14 is connected by Fibre Channel cables 32, 34, 36 to edge switches 20, 22, 24, respectively.

Edge switches 20-24 are, in turn, connected to core switches 38, 40 by inter-switch links (ISL's) 42, 44, 46, 48, 50, 52, respectively. Core switch 38 is, in turn, connected to storage devices 16, 18 by Fibre Channel cables 54, 56, respectively, and core switch 40 is connected to storage devices 16, 18 by Fibre Channel cables 58, 60, respectively.

Edge switches 20-24, 54-58 are switches on the logical outside of the core-edge fabric 10. The ports on the edge switches 20-24, 54-58 include F_Ports for connection to N_Ports of nodes such as application servers 12, 14 and storage servers 16, 18. Core switches 38, 40, also known as core fabric switches, are the switches at the logical center of the core-edge fabric 10. Generally, there are at least two core switches per core-edge fabric to provide resiliency within the fabric. The core switches 38, 40 include E_Ports used for ISL's 42-52, and Fibre Channel cables 54-60. The switches 20-24, 38, 40 each include firmware that identifies the connections made between the switches (by assigning and maintaining port addresses) and, according to the Fibre Channel standard, employ a fabric shortest path first (FSPF) path selection protocol.

It is apparent from an inspection of the core-edge topology of FIG. 1 that the connection between an application server 12, for example, and a storage subsystem 16 contains redundancies so that, in the event of the failure of a switch, for example switch 20, a path remains between the server 12 and storage subsystem 16, for example, through Fibre Channel cable 28, switch 22, ISL 46, core switch 38 and Fibre Channel cable 54. The switches 20-24, 38 and 40 also employ firmware that routes traffic from multiple servers and is capable of rerouting traffic in the event of the failure of a switch or an ISL.

A disadvantage with the system shown in FIG. 1 is that, while robust and resistant to component failure, the component cost is relatively high since the cost of a switch is proportional to the number of ports that is supports. Accordingly, there is a need to provide a core-edge topology that provides resiliency and redundancy, but minimizes the number of ports required to construct a topology connecting application servers and storage servers.

### SUMMARY

The present invention is a modified core-edge topology for a Fibre Channel network that provides resiliency and redundancy to protect system integrity in the event of the failure of a component, but is less complex and less costly than prior art core-edge topologies. The core-edge topology of the present invention includes an application or host server that is connected to an edge switch by a Fibre Channel cable and that edge switch is, in turn, connected to a core switch by an ISL. The core switch is connected to a storage subsystem by a second Fibre Channel cable. Similarly, that same application server is connected to a second edge switch by a Fibre Channel cable, the second switch is connected to a second core switch by an ISL and that second core switch connected to the storage server by a Fibre Channel cable.

The result is that the system of the present invention includes two discrete fabrics, each consisting of an interconnected application server, edge switch, core switch and storage server. However, unlike the prior art design shown in FIG. 1, an application server is not connected to multiple edge switches that, in turn, are connected to multiple core switches. Unlike prior art systems, the present invention relies on the host connection to provide redundancy between fabrics.

In addition, unlike the prior art, with the present invention the core switches are not connected to edge switches that are, in turn, connected to storage subsystems. Rather, the core switches are connected directly to the storage subsystem. By eliminating the multiple interconnection, the number of ports required per switch is reduced, resulting in a substantial savings in comparison to comparable prior art topologies. In addition, this savings is achieved without loss in throughput or bandwidth. Nevertheless, in the event of the failure of a core or edge switch, the communication between the application server and storage server remains; it is simply rerouted through a different fabric.

Accordingly, it is an object of the present invention to provide a robust core-edge topology for a Fibre Channel network, a topology that is resistant to the failure of a particular component and will allow data flow between application and storage subsystems in such an event, and a topology that is relatively inexpensive to implement because of cost savings in components.

Other objects and advantages will be apparent from the following description, the accompanying drawings and appended claims.

### BRIEF DESCRIPTION OF THE DRAWINGS

FIG. 1 is a schematic of a prior art core-edge topology for a Fibre Channel network; and

FIG. 2 is a schematic diagram of a core-edge topology for a Fibre Channel network of the present invention.

### DETAILED DESCRIPTION

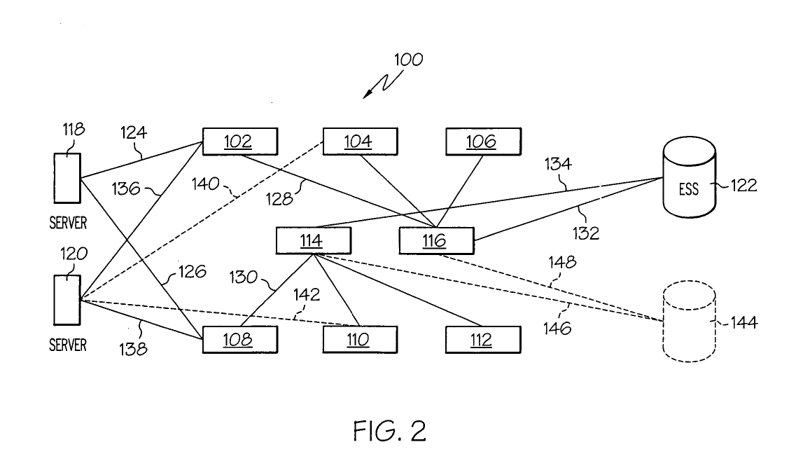

As shown in FIG. 2, the modified core-edge topology for a Fibre-Channel network includes a series of interconnected core and edge switches, generally designated 100. Specifically, the topology 100 includes edge switches 102, 104, 106, 108, 110 and 112. The topology 100 also includes core switches 114, 116. The topology 100 serves to interconnect application or host servers 118, 120 with a storage subsystem, for example, an enterprise storage server (ESS) 122.

Application server 118 is connected to edge switch 102 by Fibre Channel cable 124 and to edge switch 108 by Fibre Channel cable 126. Edge switch 102 is connected to core switch 116 by ISL 128 and edge switch 108 is connected to core switch 114 by ISL 130. Core switch 116 is connected to ESS 122 by Fibre Channel cable 132 and core switch 114 is connected to the ESS by Fibre Channel cable 134.

Similarly, application server 120 is connected to edge switch 102 by Fibre Channel cable 136 and to edge switch 108 by Fibre Channel cable 138. Alternately, application server 120 could be connected to switch 104 by Fibre Channel cable 140 and to edge switch 110 by Fibre Channel cable 142. Additional application servers (not shown) may be attached to the topology 100 at switches 102, 108 if F_Ports are available; otherwise the servers may be connected to the available F_Ports of switches 104, 106, 110, 112.

It is within the scope of the invention to connect additional storage devices, represented by storage system 144, to core switches 114, 116 by Fibre Channel cables 146, 148, respectively. The number of storage devices that may be connected to this topology 100 is limited only by the number of F_Ports on the selected model(s) of core switch(es). Furthermore, additional core switches could be added to the topology 100 to enable access to additional storage susbystems.

With the topology 100, a first fabric interconnecting application server 118 and storage subsystems 122, 144 exists through edge switch 102 and core switch 116, interconnected by Fibre Channel cables 124, 132 and 148 and ISL 128. A second, discrete fabric exists interconnecting application server 118 and storage subsystems 122, 144 with edge switch 108 and core switch 114 by way of Fibre Channel cables 126, 134 and 4 and ISL 130. Similarly, a discrete fabric is created between application server 120 and storage servers 122, 144, utilizing edge switch 102 and core switch 116 by way of Fibre Channel cables 136, 132 and 148 and ISL 128. A second fabric interconnects application server 120 and storage subsystems 122, 144 through edge switch 108 and core switch 114 by way of Fibre Channel cables 138, 134 and 146 and ISL 130. Accordingly, with each fabric, there is only a single ISL from an edge switch to a core switch.

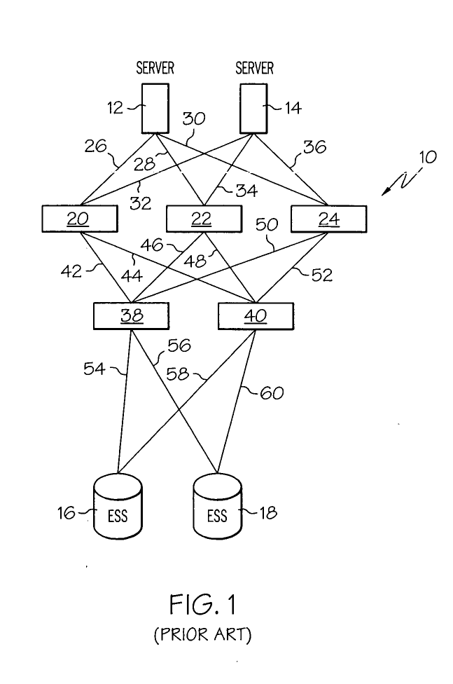

The benefit of the topology 100 shown in FIG. 2 is that there is a savings of one port (i.e., one additional E_Port is made available) per switch on the edge switches 114, 116 and core switches 102-112. The result is that a dual fabric (or multi fabric) system can be constructed with smaller switches, thereby resulting in a cost savings per switch, or additional application servers can be attached to the switches, also resulting in a cost savings, when compared to prior art topologies such as that shown in FIG. 1. The savings is accomplished by utilizing application or host servers themselves to switch between fabrics in order to provide redundancy.

A suitable edge switch is an IBM TotalStorage SAN Switch F08, available from International Business Machines Corp., or an HP StorageWorks Edge Switch 2/32, available from Hewlett-Packard Co. A suitable core switch is a McDATA Sphereon 4500 fabric switch, available from McDATA Corp., or an HP StorageWorks Core Switch 2/64, available from Hewlett-Packard Co.

While the forms of apparatus herein described constitute preferred embodiments of this invention, it is to be understood that this invention is not limited to these precise forms of apparatus, and that changes may be made therein without departing from the scope of the invention.

1. A Fibre Channel network comprising:
a server;
a first edge switch connected directly to said server;
a first core switch connected to said first edge switch;
a second edge switch connected directly to said server;
a second core switch connected to said second edge switch; and
a storage subsystem connected directly to said first and second core switches;
whereby a first fabric is formed by said server, said first edge switch, said first core switch and said storage subsystem, and a second, discrete fabric is formed by said server, said second edge switch, said second core switch and said storage subsystem, whereby said server switches between said first and said second fabrics to provide redundancy.

2. The Fibre Channel network of claim 1 further comprising a second server connected to said first and second edge switches; whereby a third, discrete fabric is formed by said second server, said first edge switch, said first core switch and said storage subsystem, and a fourth, discrete fabric is formed by said second server, said second edge switch, said second core switch and said storage subsystem.

3. The Fibre Channel network of claim 2 wherein said third fabric includes inter-switch links (ISL's) interconnecting said first edge switch and said first core switch.

4. The Fibre Channel network of claim 2 wherein said fourth fabric includes inter-switch links (ISL's) interconnecting said second edge switch and said second core switch.

5. The Fibre Channel network of claim 2 wherein said server is an application server.

6. The Fibre Channel network of claim 1 further comprising an inter-switch link (ISL) interconnecting said first edge switch to said first core switch.

7. The Fibre Channel network of claim 1 further comprising an inter-switch link (ISL) interconnecting said second edge switch to said second core switch.

8. The Fibre Channel network of claim 1 wherein said server is an application server.

9. The Fibre Channel network of claim 1 further comprising a second storage subsystem connected to said first core switch and said second core switch, whereby said second storage subsystem communicates with said server through said first and said second fabrics.

10. The Fibre Channel network of claim 9 further comprising first and second cables interconnecting said second storage subsystem to said first core switch and said second core switch, respectively.

11. A Fibre Channel network comprising:
an application server;
a first edge switch connected directly to said application server;
a first core switch connected to said first edge switch by an ISL;
a second edge switch connected directly to said server by an ISL;
a second core switch connected to said second edge switch by an ISL; and
a storage subsystem connected directly to said first and second core switches;
whereby a first fabric is formed by said application server, said first edge switch, said first core switch and said storage subsystem server, and a second, discrete fabric is formed by said application server, said second edge switch, said second core switch and said storage subsystem, whereby said application server switches between said first and said second fabrics to provide redundancy.

12. The Fibre Channel network of claim 11 further comprising a second storage subsystem connected to said first core switch and said second core switch, whereby said second storage server communicates with said server through said first and said second fabrics.

13. The Fibre Channel network of claim 12 further comprising first and second cables interconnecting said second storage server and said first and said second core switches, respectively.

14. A Fibre Channel network comprising:
first and second application servers;
a first edge switch connected directly to said first and second application servers;
a first core switch connected to said first edge switch by an ISL;
a second edge switch connected directly to said first and second application servers;
a second core switch connected to said second edge switch by an ISL; and
a storage subsystem server connected directly to said first and second core switches;
whereby a first, discrete fabric is formed by said application server, said first edge switch, said first core switch and said storage subsystem, a second, discrete fabric is formed by said application server, said second edge switch, said second core switch and said storage subsystem, a third, discrete fabric is formed by said second application server, said first edge switch, said first core switch and said storage subsystem, and a fourth, discrete fabric is formed by said second application server, said second edge switch, said second core switch and said storage subsystem, whereby said first application server switches between said first and second fabrics, and said second application server switches between said third and fourth fabrics to provide redundancy.

15. A Fibre Channel network comprising:
first and second application servers;
a first edge switch connected directly to said first and second application servers;
a first core switch connected to said first edge switch by an ISL;
a second edge switch connected directly to said first and second application servers;
a second core switch connected to said second edge switch by an ISL; and
first and second storage subsystems connected directly to said first and second core switches;
whereby a first fabric is formed by said application server, said first edge switch, said first core switch and said first and said second storage subsystems, a second, discrete fabric is formed by said application server, said second edge switch, said second core switch and said first and said second storage subsystems, a third, discrete fabric is formed by said second application server, said first edge switch, said first core switch and said first and said second storage subsystems, and a fourth, discrete fabric is formed by said second application server, said second edge switch, said second core switch and said first and said second storage subsystems, whereby said first application server switches between said first and second fabrics and said second application server switches between said third and fourth fabrics to provide redundancy.
